(19) United States
(12) Patent Application Publication
(10) Pub. No.: US 2011/0058025 A1
(43) Pub. Date: Mar. 10, 2011

(54) LEFT AND RIGHT SHUTTER CONTROL USING VISIBLE LIGHT EMITTER

(76) Inventor: Edward D. Knapton, Spring, TX (US)

(21) Appl. No.: 12/555,136

(22) Filed: Sep. 8, 2009

(51) Int. Cl. H04N 13/04

(52) U.S. Cl. 348/53; 348/E13.075

(57) ABSTRACT

Methods and means related to viewing three-dimensional images are provided. Three-dimensional imagery is displayed on an electronic display of a laptop computer or other suitable device. A light-emitting device that is integral to the laptop is controlled to provide shutter synchronization signals to a pair of three-dimensional viewing glasses. The light-emitting device can also be controlled to provide a user with status information for a camera or other feature of the laptop. Materials and user time are conserved by using a built-in resource of the laptop rather than requiring a single-purpose peripheral device.

### BACKGROUND

Electronic displays are used for providing three-dimensional imagery that is viewed by way of special glasses worn by a user. Left and right shutters of the viewing glasses are individually opened and closed in accordance with image components depicted on the display. Laptop computers and other devices can thus be used for presenting three-dimensional videos and still images.

However, shutter synchronization signaling must be provided to the viewing glasses in order for the three-dimensional images to appear correctly. Providing for such synchronization signaling without the use of dedicated-purpose peripherals or direct wiring is desirable. The present teachings are directed to the foregoing concerns.

### BRIEF DESCRIPTION OF THE DRAWINGS

The present embodiments will now be described, by way of example, with reference to the accompanying drawings, in which:

FIG. 1 depicts a diagrammatic view of a system according to one embodiment;

FIG. 2 depicts a block diagram of a system according to one embodiment;

FIG. 3 is a flow diagram depicting a method according to one embodiment.

### DETAILED DESCRIPTION

### Introduction

Means and methods for controlling a pair of three-dimensional (3D) viewing glasses are provided by the present teachings. Three-dimensional imagery is displayed on an electronic display or similar resource of a laptop computer or other device. A light-emitting device, which is integral to the laptop, is controlled to provide shutter synchronization signals to the pair of 3D viewing glasses. The light-emitting device can also be controlled to provide a user with status information for a camera or other feature of the laptop. Material and user time are conserved by using an existing, built-in resource of the laptop or electronic monitor rather than requiring an additional, special-purpose device.

In one embodiment, a method includes modulating a signal output from a visible-spectrum light-emitting device. The signal is modulated to control left and right shutters of a pair of three dimensional viewing glasses. The visible-spectrum light-emitting device is supported proximate to an electronic display.

In another embodiment, an apparatus includes an electronic display and a light-emitting device supported proximate to the electronic display. The light-emitting device is configured to provide an output in the visible spectrum. The apparatus also includes a controller configured to modulate output from the light-emitting device in synchronization with a displaying of left and right components of three-dimensional imagery on the electronic display.

In yet another embodiment, a controller is configured to modulate output from a visible spectrum light-emitting device in synchronization with a displaying of left and right components of three-dimensional imagery.

### Illustrative System

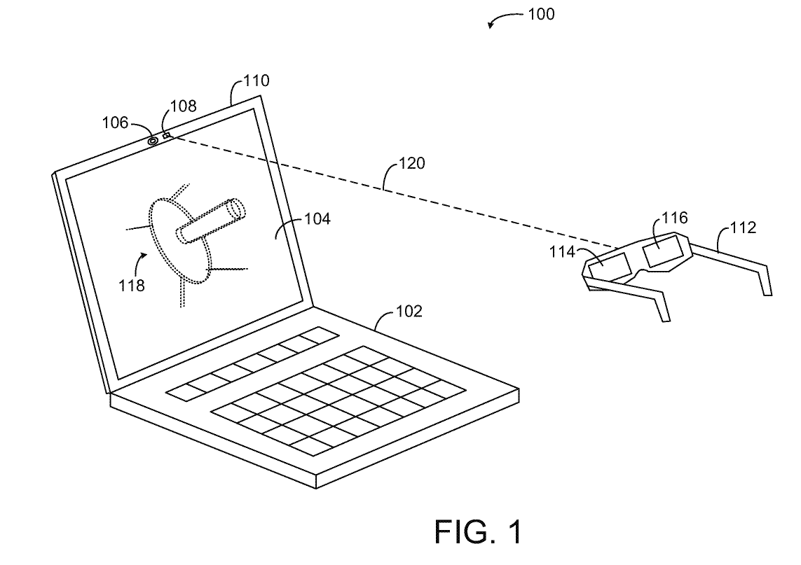

Reference is now directed to FIG. 1, which depicts a diagrammatic view of a system 100. The system 100 is illustrative and non-limiting with respect to the present teachings. Thus, other systems can be configured and/or operated in accordance with the present teachings.

The system 100 includes a laptop computer (laptop) 102. The laptop 102 can be defined by any such device that includes resources according to the present teachings. The laptop 102 includes an electronic display 104 and a camera 106 fixedly supported proximate to the electronic display 104.

The laptop 102 also includes a status light 108. The status light (i.e., light emitter, or light-emitting device) 108 is controlled as described hereinafter and, in one mode of operation, is configured to indicate the operating status of the camera 106. In one embodiment, the status light 108 is defined by a light emitting diode (LED) configured to emit light in the visible spectrum.

In one embodiment, the status light 108 is controlled to be on when the camera 106 is operating normally and off when the camera 106 is shut down. Other status indicating functions can also be performed by way of the status light 108. The status light 108 is fixedly supported near a top edge 110 of the laptop 102. The status light 108 is a built-in resource of the laptop 102 as originally provided by the laptop 102 manufacturer and is not considered a peripheral or “add-on” for purposes of the present teachings.

The system 100 also includes a pair of three-dimensional viewing glasses (glasses) 112. The glasses 112 include a left shutter 114 and right shutter 116 that are independently open-able and closable. In one embodiment, the respective shutters 114 and 116 are defined by liquid crystal apertures or “windows” that can be rapidly and independently toggled between clear (i.e., open) and opaque (i.e., closed) conditions. The glasses 112 further include on-board circuitry and a power source (not shown, respectively) as required to perform normal operations of the respective shutters 114 and 116. The glasses 112 generally operate as known to one having ordinary skill in the three-dimensional viewing arts, and further elaboration is not required for an understanding of the present teachings except as noted below.

Illustrative operation of the system 100 is as follows: The laptop 102 displays a three-dimensional image (3D or stereoscopic image) 118 in the electronic display 104. Specifically, the image 118 is composed of a left component and a right component that are rapidly and alternately provided on the electronic display 104. Thus, the left component alone is displayed, and then the right component alone is displayed, and then the left component alone, and so on. The immediate foregoing is true of either a still 3D image or a video progression of 3D images such as a movie or cartoon segment.

The status light 108 is controlled (i.e., modulated) so as to emit a synchronization signal 120. The synchronization signal 120 is received by the glasses 112 and is used to synchronize the operations (i.e., opening and closing) of the left and right shutters 114 and 116 (respectively) during the displaying of the three-dimensional image 118. In this way, a user of the three-dimensional viewing glasses 112 sees the image 118 as having three dimensional characteristics (i.e., height, width and depth).

In a general and non-limiting sense, the system 100 operates such that three-dimensional imagery can be viewed by a user wearing appropriate viewing glasses. The left shutter of the glasses is open and right shutter is closed during display of a left image component. The right shutter of the glasses is then open and left shutter is closed during display of right image component. Rapid toggling between the left and right component displays, and the corresponding opening and closing of the left and right shutters, is synchronized by way of a light beam signal in the human visible spectrum.

The light beam signal is emitted by a resource (e.g., an LED, etc.) that is inherent to the laptop computer, and a dedicated-purpose peripheral device is not required. As result, a user is not burdened with the cost or setup time required of such a peripheral. Additionally, a built-in feature of the laptop computer—namely, the camera status light—serves another function and provides additional value to the user.

### First Illustrative Embodiment

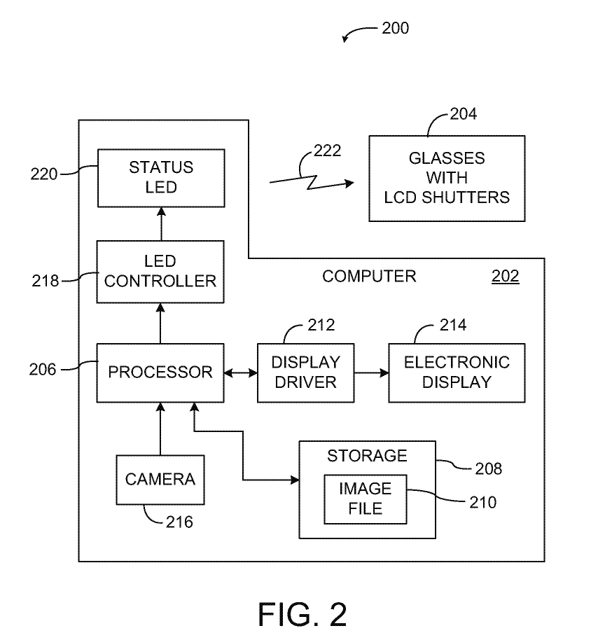

FIG. 2 is a block diagram depicting a system 200 according to an embodiment of the present teachings. The system 200 is illustrative and non-limiting in nature. As such, other systems are contemplated by the present teachings. The system 200 includes a computer 202 and a pair of three-dimensional viewing glasses 204.

The computer 202 includes at least one processor 206. The processor 206 is configured to control various normal operations of the computer 202 in accordance with a computer-readable program code. The computer 202 includes storage 208 that is configured to retrievably store computer-readable program code and data files as desired or required for normal operations of the computer 202. Non-limiting examples of such storage 208 include magnetic storage media, optical storage media, read-only memory (ROM), random-access memory (RAM), non-volatile storage memory, etc. Other suitable forms of computer-accessible storage can also be used. The storage 208 includes an image file 210 that corresponds to three-dimensional imagery (e.g., video, etc.) that can be displayed by the computer 202.

The computer 202 also includes a display driver 212 and an electronic display 214. The display driver 212 is configured to drive (operate, or control) the electronic display 214 in accordance with commands provided by the processor 206. For non-limiting example, the processor 206 can access (i.e., read) the image file 210 within the storage 208 and provide corresponding command signals to the display driver 212 such that three-dimensional imagery is displayed on the electronic display 214. The computer 202 also includes a camera 216 configured to provide digital data to the processor corresponding to light and images incident thereto. The processor 206 can, under proper program-code control, store the digital data in storage 208, provide corresponding command signals to display those images on the electronic display 214, or perform other suitable operations.

The computer 202 also includes an LED controller 218 and a status light (LED) 220. The LED controller 218 is configured to receive control signals from the processor 206 and to drive (or modulate) a visible-spectrum output signal 222 from the LED 220 accordingly. In one embodiment, the LED 220 is mounted (i.e., fixedly supported) in a housing of the computer 202 proximate the electronic display 214. Additionally, the LED 220 can be located over the electronic display 214 such that a favorable line-of-site orientation is achieved with respect to the three-dimensional viewing glasses 204.

In one non-limiting operating scenario, the LED controller 218 is signaled to modulate the LED 220 according to the instantaneous state (i.e., left or right component) of a three-dimensional image presented on the electronic display 214. In such a scenario, the LED 220 provides a modulated signal to the viewing glasses 204 so as to synchronize the open and closed condition of the left and right shutters (e.g., 114 and 116), respectively. In another non-limiting operating scenario, the LED controller 218 is signaled by the processor 206 to turn the LED 220 on when the camera 216 is operating, and to turn the LED 220 off when the camera 216 is not operating. The LED controller 218 can also be used to drive the LED 220 in accordance with other operating states or functions of the computer 202.

The LED controller 218 can be defined by any suitable electronic circuitry as needed to interface control signals from the processor 206 to the status light 220. Such interface functions can include, without limitation, sample-and-latch, level shifting, voltage-to-current conversion, frequency- or phase-modulation, etc. In one embodiment, the LED controller 218 is defined by a processor or microcontroller configured to operating according to a computer-readable program code. In another embodiment, the LED controller 218 is defined by digital, analog or hybrid circuitry. In yet another embodiment, the LED controller 218 is defined by the processor 206 itself. Other suitable embodiments can also be used. One having ordinary skill in the electronic and related arts can appreciate that the LED controller 218 can be variously and suitably defined so that the LED 220 can be properly modulated according to processor 206 signaling.

### First Illustrative Method

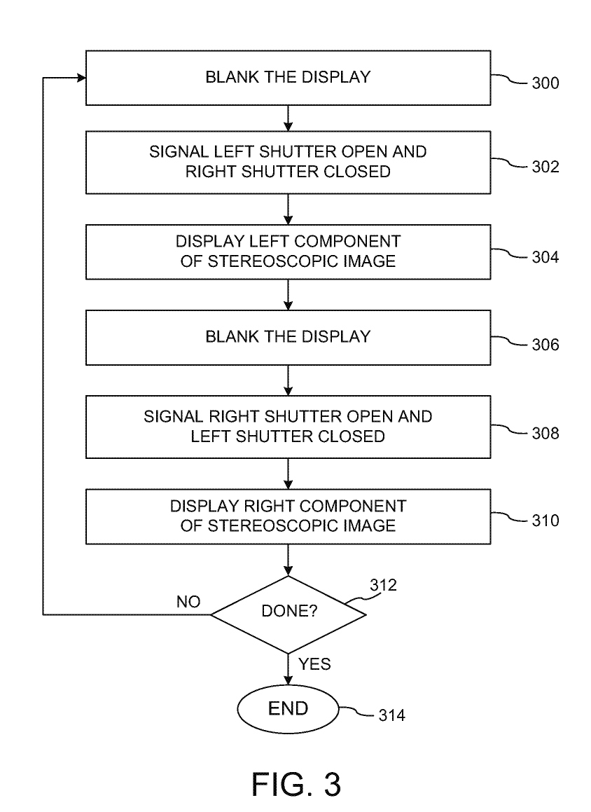

FIG. 3 is a flow diagram depicting a method according to one embodiment of the present teachings. The method of FIG. 3 includes particular operations and order of execution. However, other methods including other operations, omitting one or more of the depicted operations, and/or proceeding in other orders of execution can also be used according to the present teachings. Thus, the method of FIG. 3 is illustrative and non-limiting in nature. Reference is also made to FIGS. 1-2 in the interest of understanding the method of FIG. 3.

At 300, an electronic display is set to a blank condition. For purposes of illustration, it is assumed that an electronic display 214 is set to a blank state by way of processor 206 control.

At 302, a signal is sent to a pair of three-dimensional viewing glasses so as to cause a left shutter to open and a right shutter to close. For purposes of the ongoing example, it is assumed that a status LED 220 is modulated to send a signal 222 to a pair of glasses 204. The left window is made clear and the right window is made opaque in response to the signal 222.

At 304, a left component of a stereoscopic image is displayed on the electronic display. For purposes of the ongoing example, it is assumed that a left component of a three-dimensional image 118 is displayed on the electronic display 214. This left component is displayed (dwells) for a suitable period of time. In one embodiment, the left component is displayed for two to four milliseconds. Other display times can also be used.

At 306, an electronic display is set to a blank condition. For purposes of illustration, it is assumed that the electronic display 214 is set to a blank state by way of processor 206 control.

At 308, a signal is sent to the pair of three-dimensional viewing glasses so as to cause a right shutter to open and a left shutter to close. For purposes of the example, it is assumed that the status LED 220 output signal 222 is modulated to cause the right window to be made clear and the left window to be made opaque.

At 310, a right component of a stereoscopic image is displayed on the electronic display. For purposes of the ongoing example, it is assumed that the right component of a three-dimensional image 118 is displayed on the electronic display 214. The right component is displayed (dwells) for a suitable period of time. In one embodiment, the left component is displayed for two to four milliseconds. Other display times can also be used.

At 312, it is determined if the stereoscopic image display is complete. If the three-dimensional imagery has been fully displayed, then the method proceeds on to 314 where the process is ended. If the three-dimensional imagery has not yet been fully displayed, then the method proceeds back to 300 and the display of stereoscopic imagery (still or video, etc.) is continued.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A method, comprising:
modulating a signal output from a visible-spectrum light-emitting device, the signal modulated to control left and right shutters of a pair of three-dimensional viewing glasses, the visible-spectrum light-emitting device being supported proximate to an electronic display.

2. The method according to claim 1, the visible-spectrum light-emitting device being integral to a housing of the electronic display.

3. The method according to claim 1, the visible-spectrum light-emitting device being part of a laptop computer.

4. The method according to claim 1, the visible-spectrum light-emitting device being defined by a camera status light of a laptop computer.

5. The method according to claim 1 further comprising alternately displaying left and right components of three-dimensional imagery on an electronic display, the modulating of the signal synchronized to the displaying.

6. The method according to claim 5 further comprising selectively opening and closing the left and right shutters of the pair of three-dimensional viewing glasses in accordance with the signal.

7. An apparatus, comprising:
an electronic display;
a light-emitting device supported proximate to the electronic display, the light-emitting device configured to provide an output in the visible spectrum; and
a controller configured to modulate output from the light-emitting device in synchronization with a displaying of left and right components of three-dimensional imagery on the electronic display.

8. The apparatus according to claim 7, the light-emitting device being defined as a status indicator for a camera.

9. The apparatus according to claim 7 further comprising a camera, the controller further configured to control the light-emitting device in accordance with an operating status of the camera.

10. The apparatus according to claim 7, the controller configured to operate in accordance with a computer-readable program code.

11. The apparatus according to claim 7, the apparatus being defined by a laptop computer.

12. A controller configured to modulate output from a visible spectrum light-emitting device in synchronization with a displaying of left and right components of three-dimensional imagery.

13. The controller according to claim 11, further configured to modulate output from the visible spectrum light-emitting device in accordance with an operating status of a camera.

14. The controller according to claim 11, the controller being part of a laptop computer.
